(19) United States
(12) Patent Application Publication
(10) Pub. No.: US 2014/0220542 A1
(43) Pub. Date: Aug. 7, 2014

(54) Educational Game

(71) Applicant: Alexandra H. Wolf, New York, NY (US)

(72) Inventor: Alexandra H. Wolf, New York, NY (US)

(21) Appl. No.: 14/175,745

(22) Filed: Feb. 7, 2014

Related U.S. Application Data
(60) Provisional application No. 61/762,056, filed on Feb. 7, 2013.

(51) Int. Cl. G09B 7/00

(52) U.S. Cl. CPC G09B 7/00
USPC 434/362

(57) ABSTRACT

An educational tool is presented that provides a user with the ability to easily relate and understand how a complex subject's facts and concepts relate in a way which enhances the speed, ease, and depth a subject can be learned.

### PRIORITY AND RELATED APPLICATION

This application claims priority to U.S. Provisional Patent Application Ser. No. 61/762,056, filed Feb. 7, 2013, entitled “Educational Game,” which is hereby incorporated by reference in its entirety.

### FIELD OF THE INVENTION

The present invention relates to educational tool or game based on formulaic underpinnings

### BACKGROUND OF THE INVENTION

A number of educational tools exist in the market. Since neural networks of information are formed in the brain in two ways—by connection to prior information and by repetition-educational tools are desired that can mimic these designs. A deep understanding and mastery of a subject is not simply a collection or sequence of facts, but an interrelated web of concepts which connects and organizes facts, so conclusions may be drawn and more questions asked. An educational tool is desired that will render complex subjects in simple, logical ways that mirror how the brain learns. For instance use of taxonomies, classifications, and hierarchies will serve to arrange facts and concepts for better learning by individuals. Learning can further be enhanced by providing a classification system that augments learning by organizing the subject matter in the brain of the user. Concepts and materials that can be neatly organized in the user's mind enable one to quickly learn and digest relevant pieces and types of information. Connections can also be easily made in a network, which is built mentally around the subject matter. In addition to organizing concepts, learning can be enhanced by providing text, pictures, sounds, images and color-coding etc., all types of information desired to be learned. An educational tool that provided the above would serve to enhance learning, allow many styles of learning to adapt information, and facilitate learning by those who have learning disabilities.

### BRIEF SUMMARY OF THE INVENTION

The present invention is a formula based educational tool or game. There are a number of modes used in the invention, such as, but not limited to, quiz, explore and drill modes.

### BRIEF DESCRIPTION OF THE DRAWING

FIG. 1 is a first screen shot of the graphical user interface of the subject invention.

FIG. 2 is a second screen shot of the graphical user interface of the subject invention.

FIG. 3 is a third screen shot of the graphical user interface of the subject invention.

FIG. 4 is a fourth screen shot of the graphical user interface of the subject invention.

FIG. 5 is a fifth screen shot of the graphical user interface of the subject invention.

FIG. 6 is a sixth screen shot of the graphical user interface of the subject invention.

FIG. 7 is a seventh screen shot of the graphical user interface of the subject invention.

FIG. 8 is an eighth screen shot of the graphical user interface of the subject invention.

FIG. 9 is a ninth screen shot of the graphical user interface of the subject invention.

FIG. 10 is a tenth screen shot of the graphical user interface of the subject invention.

FIG. 11 is a eleventh screen shot of the graphical user interface of the subject invention.

FIG. 12 is a twelfth screen shot of the graphical user interface of the subject invention.

FIG. 13 is a thirteenth screen shot of the graphical user interface of the subject invention.

FIG. 14 is a fourteenth screen shot of the graphical user interface of the subject invention.

FIG. 15 is a fifteenth screen shot of the graphical user interface of the subject invention.

FIG. 16 is a block diagram showing a configuration of an embodiment of the invention in accordance with an aspect of the present invention.

### DETAILED DESCRIPTION OF THE INVENTION

The invention has three modes of play quiz, explore and drills. In quiz mode the user selects a target to define from a group of preloaded choices. In explore mode there is no target selected, and answers “grey out” where not applicable progressively along the formula of the provided number of categories, eight for instance, as selections are made. In drill mode the user selects from the provided number of categories of questions to quiz the user on randomly assigned groups of targets. Depending upon which mode is used, the targets are different groups, and those targets can be added at a later time.

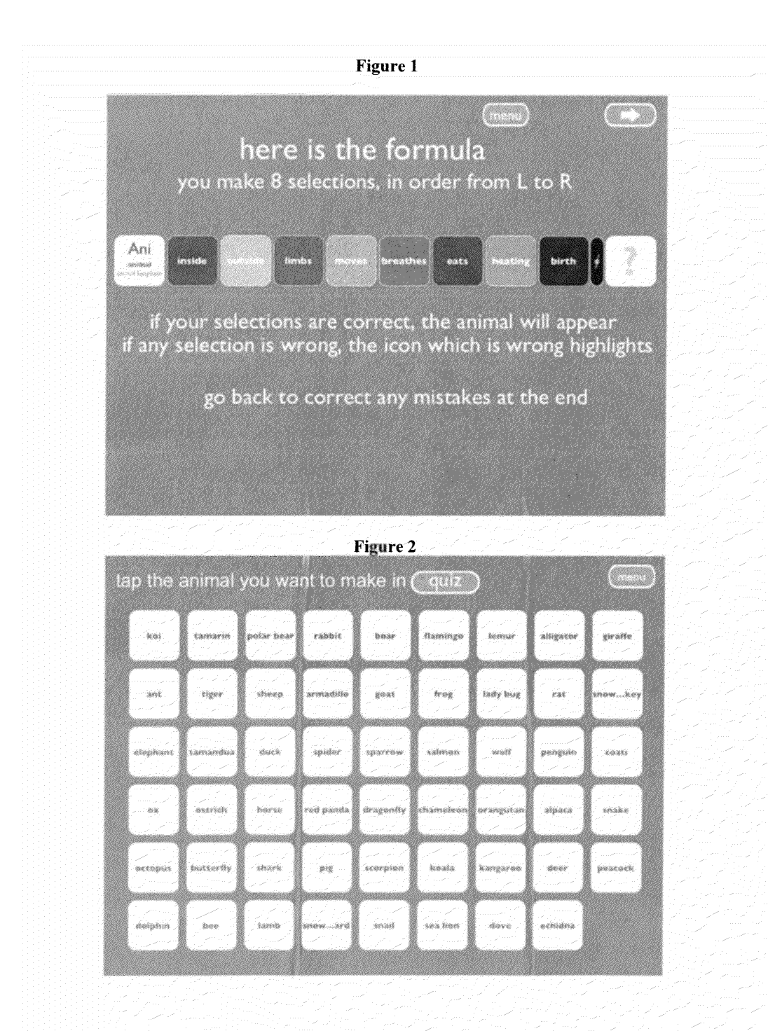

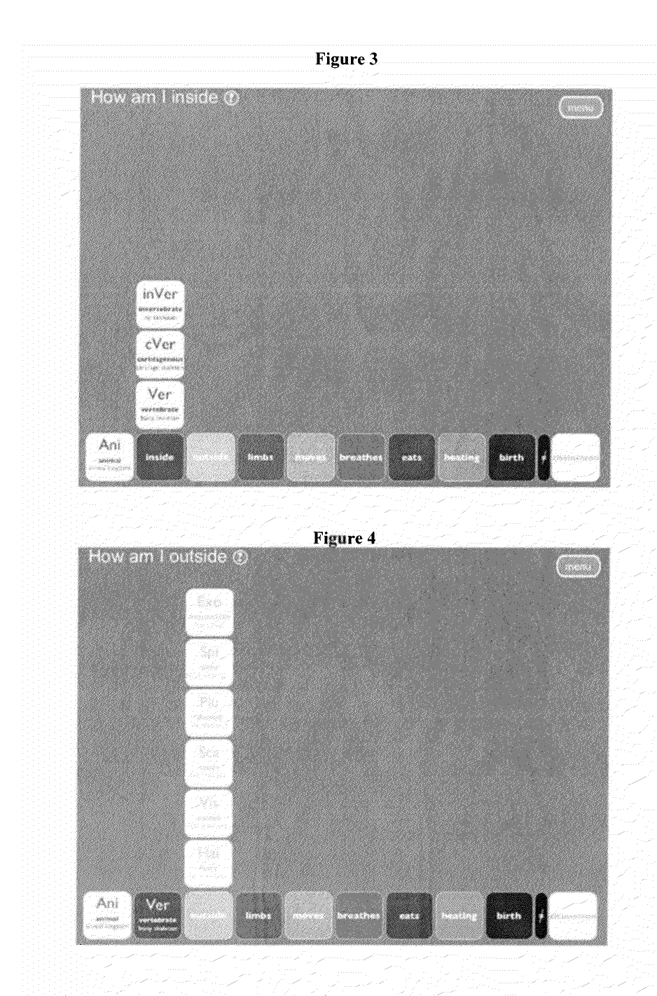

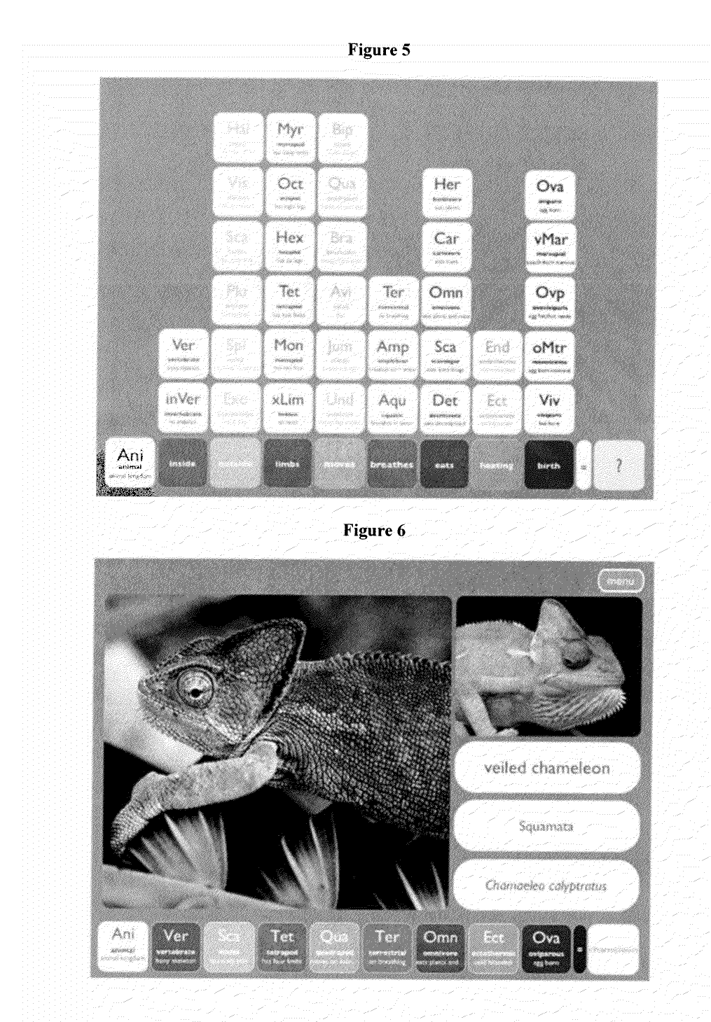

In quiz mode, a horizontal formula of a number of questions, 8 for example, appears along the bottom of the screen and the user makes selections from a series of choices which appear vertically above each question tile to correctly define a target. The targets in quiz mode are selected from a group of targets prior to entering the formula phase. Thus, in a quiz mode, a user defines a target through a series of choices. In one embodiment of the invention one layer of the formula with 8 categories is provided. For instance, if the invention is based on the animal kingdom, the target is an animal. The user must define the intended animal using a number of characteristic choices such as and not limited to inside, outside, limbs, moves, breathes, eats, heating and birth. The quantity of characteristics is not limited in number. The invention need not be limited to eight characteristics and may be more or less See FIGS. 1-4. FIG. 1 is a Help screen showing the formula, with each question in an icon shaped tile, times 8 in this case. FIG. 2 is a Quiz Mode showing an animal selected as a target. FIG. 3 still the Quiz Mode shows the first selection above the first question “How am I inside?” FIG. 4 also the Quiz Mode shows the second selection that appears above the second question. This continues for all 8 selections in this case. FIG. 5 shows the full suite of icons above their questions.

The user must decide the characteristics of the chameleon for the inside, outside, limbs, moves, breathes, eats, heating and birth choices.

A correct series of answers for he sequence of listed characteristics would be VER—vertebrate having a bony skeleton, SCA—scales having scaly skin, TET—tetrapod having four limbs. QUA—quadruped moving on four limbs, TER—terrestrial being air breathing, OMN—omnivore, eats plants and animals, ECT—ectothermic, cold blooded, OVA—oviparous, egg born. See FIG. 6 which shows the chameleon as the final answer.

If the user makes a mistake in any of the characteristic choices the incorrect characteristic is highlighted to be re-selected correctly. At the end of successful selections, the target animal, in this case “chameleon”, will be described and shown as a picture. Throughout the course, the user has a help option that provides details on the characteristics. The help button will bring more text pop-ups, as well as video in some cases. The ability to have the text read to you is part of the audio feature.

The invention uses a series of icons to describe the characteristics of each choice, in each category, which are appear vertically above each given icon. In one embodiment, the categories are up to 8 per line but may be flexible to cover more or less, per species. The non-limiting example provided herein is for the animal kingdom but could also apply to the plant kingdom, or school education such as medical school, business school, etc.

A feature of the invention is its simplicity in rendering a formula structure for a data set. The data sets can be variable, and apply to different disciplines, and data entry can be done in a simple way in xml files to upload the data sets to the platform. Another feature of the invention—just as the data is easy to obtain for the user, the data sets are easy to load into the back end.

The invention platform allows a creator to take large data sets and have a user move through them in a quiz or explore mode to learn more about the subject of the data set in a simple and effective way. The invention permits the rendering of hugely complex data sets with multiple icons and other variables in a way which the user finds not only pleasant and clear, but creates strong connections in layers of information, which other formats of study are not able to achieve with such ease. Repetition of the classification in game format is more engaging, presented like a puzzle to unlock, yet provides the repetitive enforcement necessary to learning.

In one embodiment, color may be used as one of many organizational layers to organize categories. Photographs and video may also be used as visual clues to help novice users make informed choices. For example in the “moves” question, the tiles swipe to video of animals in motion, and the “breathes” icons have videos showing air breathing as well as aquatic respiration through gills. Audio may be used as a feature for pre-readers and people who are impaired or need additional support modalities to learn effectively. The audio can speak the questions and text to the user.

The quiz mode of the platform is designed like a game. Right answers can lead to point gathering, and can be measured by parents or teachers to evaluate progress. This feature can time the user in making their selection, as well as document how many mistakes they made per species—and as such it can be used as a test module. This feature can be disabled for the learning process when discovery and exploration are the more desired target activities and time is not pressing. The platform is useful as a learning aid and study guide, as well as professional uses. As a study aid it is powerful and relevant from the ages of preschoolers through PhD level coursework.

In “explore mode”, a target is not defined, rather a target will be made based on a series of selections of characteristic the user choses for each of the formula icons. The user is allowed to make selections progressively along a formula without selecting a specific a target. Here, based on user choices made in a series of available characteristics, the invention will define a target that qualifies for all the characteristics selected by the user. The end result is a target that is unique to the users selection of available characteristics. As the user makes a selection of a characteristic, the subsequent characteristic choices are narrowed for the user until a target/targets is defined. The user is allowed to choose characteristics until there are no more characteristics available for a target/targets. The user is shown a horizontal formula of icons of a number of questions. Vertically above each formula icon, each available characteristic is shown to the user. The user can only select the vertical characteristic above a formula icon starting on the left most formula icon. As the user selects a choice, the following choice of characteristics, in moving from left to right, will adapt to the users previous selection and will be hidden if there is no possible target that can be defined with the hidden characteristic. For instance, if the invention is based on the animal kingdom, the target will be an undefined animal. The user will be allowed to make a selection for characteristics of the first formula icon, in this case “inside” which has a selection of characteristics called “vertebrate” and “invertebrate.” If the user selects “vertebrate”. the subsequent characteristics for the following formula icons will adapt to the user selection. In this case, for the formula icon “outside”, once the user has selected the characteristic “vertebrate”, the available choice for the characteristic choices of the “outside” formula icon will be “exoskeleton”, “spiny”, “plumed”, “scales”, “viscous”, and “hairy”. If the user choses “plumed”, the subsequent characteristics for the following formula icons “limbs” will only show “quadruped”. The characteristics choice of “myriapod”, “octopod”, “hexapod”, “monopod”, and “limbless” will not be shown as there is no target animal that can be made with the hidden choices. By working in the reverse format to quiz mode, the explore mode allows the user to focus their inquiry on how the animals are grouped, a function which works to support knowledge of the individual animal characteristics learned in quiz mode. This placement of the groups in the larger data set of all animals reinforces knowledge of animals' characteristics.

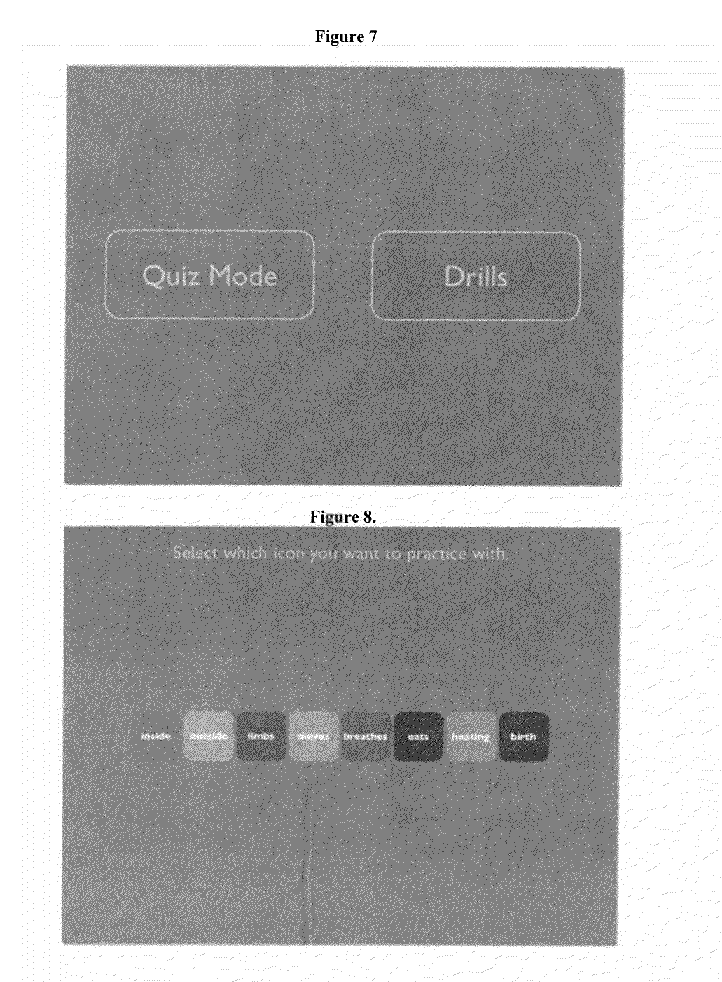

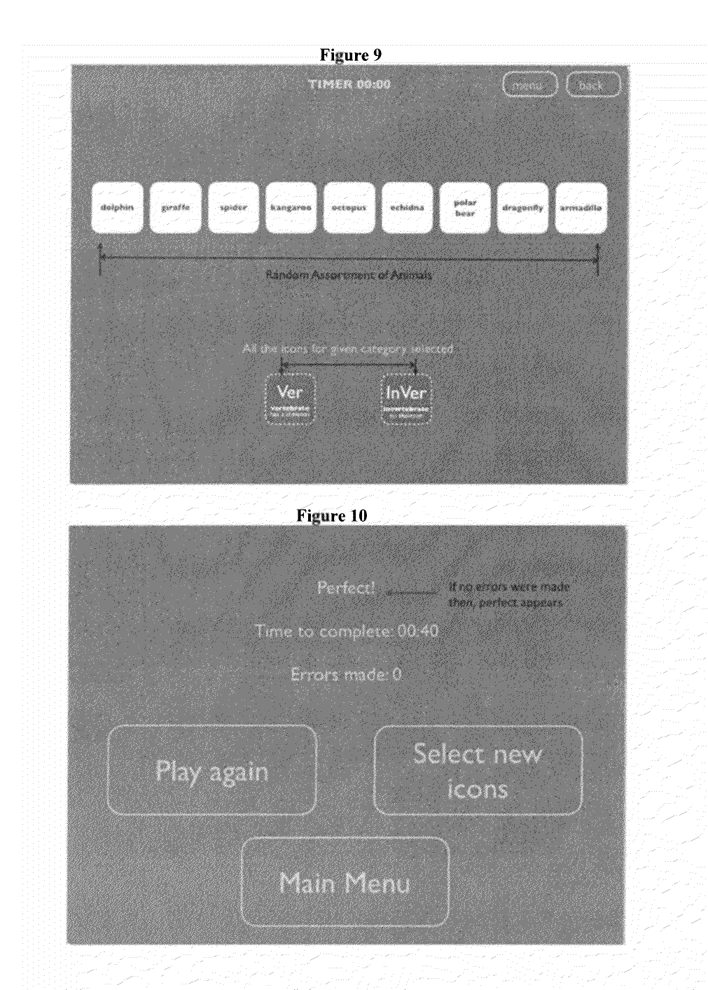

In drill mode the user selects from the provided number of categories of a horizontal formula of choices, 8 for example, in order to classify a random target to a selection of characteristics for the selected formula icon. The random selection of targets appears above the characteristics choices. The user is allowed to drag each target onto the appropriate characteristic choice. The user drags each target until there are no more targets available to be dragged. If the user dragged a target into an incorrect characteristic choice, the target/targets will reappear and the user will be able to drag the targets again to the same set of characteristics choices. The user is allowed as many turns as needed until each target is dragged into the correct characteristics choices. Once the user has correctly identified each target, a screen will show the time the user took to complete the task and how many tries the user attempted. See FIGS. 7-11. FIG. 7 shows a Drill Mode where drills are chosen. FIG. 8 shows the category for drills to be selected. FIG. 9 shows random selection of animals above target icons. FIG. 10 shows the drill results. FIG. 11 shows a Teacher Mode where one may choose features to explore.

The invention is therefore two-fold and interlocking 1) a classification system, which drives 2) the back end data system and front end UX/UI of a tablet app—and the purpose of it is to make complex subjects easier to learn. Complex subjects are rendered simpler to understand and faster to learn by virtue of the classification's 1) conceptual divisions paired with 2) graphical icons and 3) visual examples. The invention may be used with complex subjects such as but not limited to biology (our example used is zoology), to other sciences, letters and languages, history, and visual based subjects including geometry, and specialty symbol/character/notations.

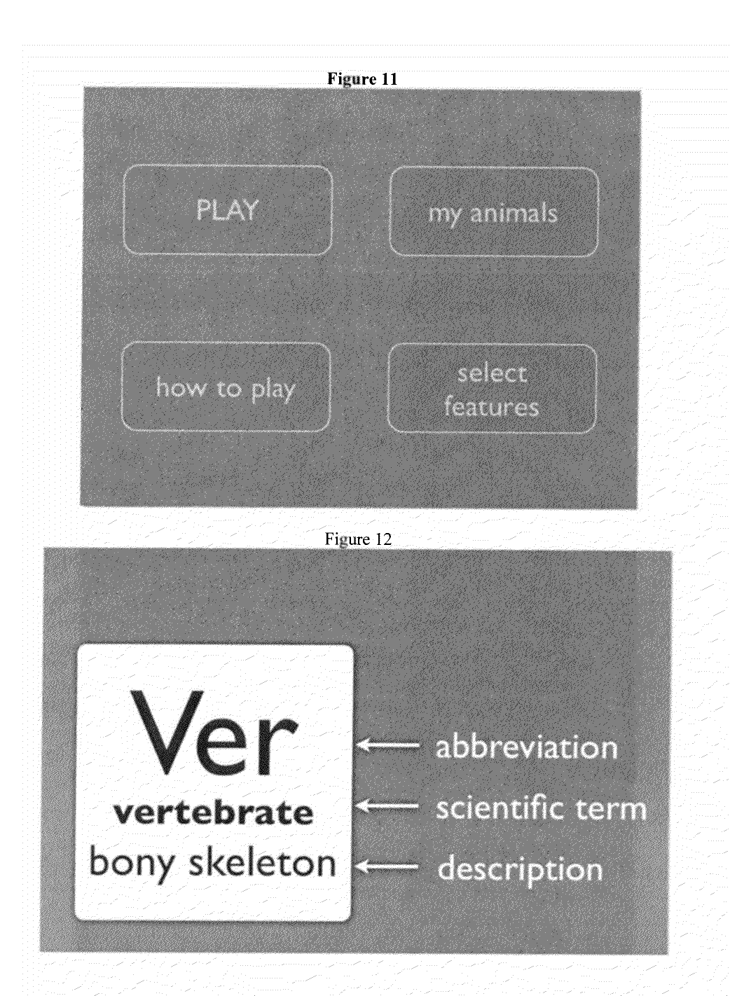

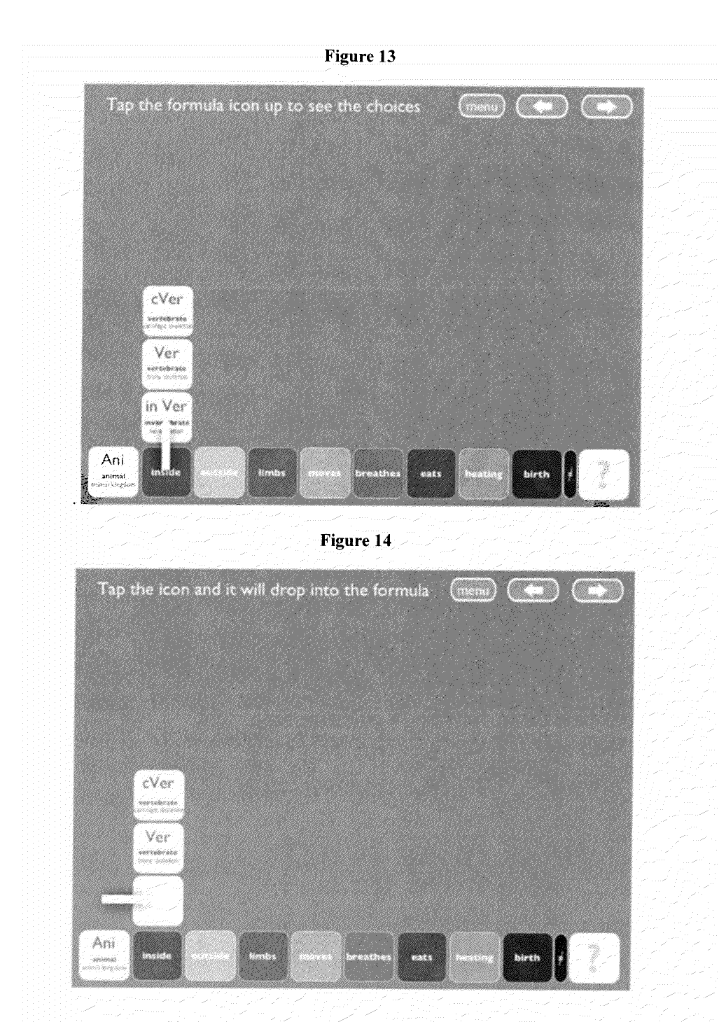

Looking to FIG. 12, atomic units used in the classification system are individual graphic icons. FIG. 12, shows a single icon, the basis of the whole classification system. A suite of icons for a subject constitutes the backbone of the invention. The icons define 1) the back end data categories, as well as the 2) front end UI of the app “tiles (or buttons)” which appear horizontally in a progressive linear format which mimics a formula. Selections above each category choice in the formula pop up vertically, and selections are “tapped” to correctly answer the “questions” about the target subject (See FIG. 13-14). FIG. 13 shows a Help Mode where the vertical stack of icon choices are shown above questions. FIG. 14 shows the tapped icon, which will then drop down into the formula row.

The classification icon is built from three parts whose graphic design translates a 1) scientific term into 2) a 3-5 letter abbreviation and 3) a plain language description, each in distinct font sizes and weights consistent for each icon (see FIG. 12).

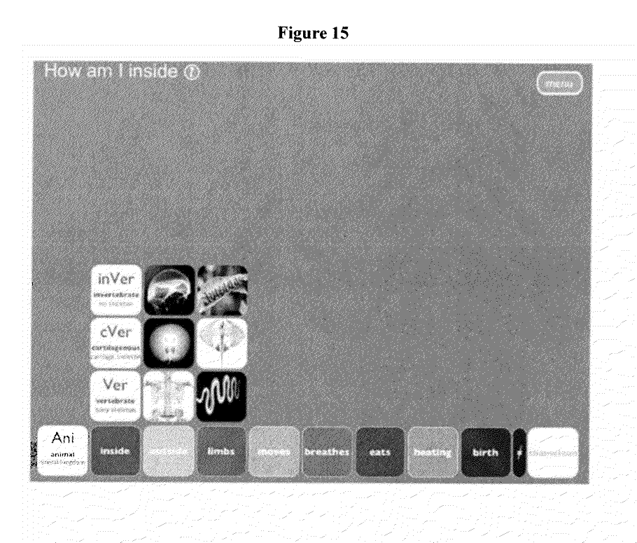

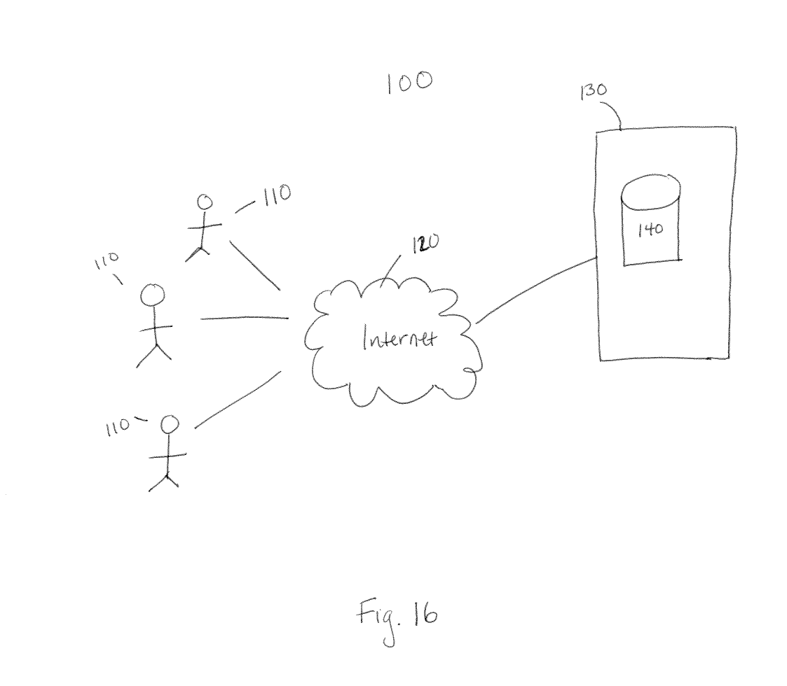

Visual images (photos, videos or illustrations), which are accessed by “swiping” the icon horizontally, provide references to enhance visual understanding by showing examples of the icon in question (FIG. 15). FIG. 15 shows the ability to “swipe ” across the icon to reveal pictures, which give additional visual clues to help the user answer the question.

To render the classification system more visually memorable, and hence more effective, the categories of questions in the formula, and their answer icons, are color-coded - vertical stacks of icons appear above the question type in the same color. This not only speeds the repetitive use of the system, but reinforces the learning. The icon system format is highly logical in its deconstructing subjects into basic layers of information relevant to each subject.

The invention is suitable for users of any age. It can be suited to be accessible to young children, including those learning to read. The invention is designed to grow with the child's age and/or increasing knowledge, and so will extend to second, third and so on, layers of categories with increasingly refined information at each layer. A color coding system will extend throughout all the layers, providing either deeper definitions from one layer of icons to another layer of icons within the same color, or providing related information from one layer 1 to the next layer, etc. to stay consistent.

As mentioned above the non-limiting example used to explain the present invention is the animal kingdom, but the invention may be used in other areas such as the natural science including categories of animals, plants, fungi, bacteria, viruses, and geology, medicine and health for study and EMR systems, including admissions to hospitals, clinics and offices, as well as patient health records. It can also be applied to business school and studies of types of business models. Also, chemistry, physics, engineering, as well as, mathematics, multiple disciplines, and music. Learning of color, pattern and structure systems organic and geometric, of language arts, foreign languages, and writing, history and culinary fields including oenology.

The invention may be applied to any computing device such as computers, tablets, other personal devices and work on any platform. Referring now to FIG. 16, users 110 are shown accessing the invention 130 over the internet 120. The invention is provided at 130 with database 140 that stores the educational formulae, characteristics and so forth of the invention.

Additional Functionalities

Upon completion of the correct animal, the answer page appears and there are many additional functionalities and places to insert relevant content for user discovery on that page. Additional content including text, graphics, diagrams, photos and videos of or about the animal, as in this case, or the target subject in another subject. This makes the platform function as a learning game with additional chances for interactive learning akin to a book, an e-book, a televised/video program or a science exhibit.

Additionally, the layers of the classification system can be made to intersect into more complex webs of information, once the user has “completed” a number of target animals. The completed animals can be compared in data sets of their own, a functionality which is appealing to teachers. We will be adding those module to this patent once we have the completed wireframes.

Additional functionality or the classification system to act as a front end UI to layers of large data sets is possible with the invention, and would streamline the visualization process needed to make sense of those layers as well as overlay sets of data on each other. This is a valuable feature in the age of big data, and a most attractive solution. Upon the classification of the desired data set names of the layers, the coding can access the back end specifics for each layer and then work to present those layers individually, in pairs, or in multiple layers. This function is much like the layers in the movie Ironman's Jarvis computer, whereby multiple layers are shown at once, or can be stripped away, or brought back, to have just the data sets which interface in such a way that the relationship that exist between two or more sets of data highlight the causal, correlated or inter-relatedness of the data in question, which brings actionable conclusions to hypotheses.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A computer implemented method for deciphering an educational formula stored on a database, the method for deciphering comprising the steps of:
selecting a study object from said database, said study object having characteristics, wherein said characteristics are stored on said database;
providing said educational formula on said study object, said educational formula comprising at least one study object inquiry, each said study object inquiry having responses comprising said characteristics; and
answering each said study object inquiry by selecting said characteristic, wherein when all said characteristics that define the study object are accurately selected said study object is identified, wherein when one or more of said characteristics that define the study object are wrong said study object is unidentified.

2. The method of claim 1, further comprising correcting said characteristics that were identified as wrong, wherein when all said characteristics that define the study object are accurately selected said study object is identified, wherein when one or more of said characteristics that define the study object are wrong said study object is unidentified.
